(19) United States
(12) Patent Application Publication
(10) Pub. No.: US 2021/0142361 A1
(43) Pub. Date: May 13, 2021

(54) Method of Implementing a Digital Platform

(71) Applicant: Marsh USA, Inc., New York, NY (US)

(72) Inventors: Sastry VSM Durvasula, New York, NY (US); Satish T. Narayanan, New York, NY (US); Harish R. Naik, New York, NY (US); Joe Buselmeier, New York, NY (US); Chetan Urunkar, New York, NY (US); Arvitti Khandurie Mittal, New York, NY (US)

(21) Appl. No.: 16/681,490

(22) Filed: Nov. 12, 2019

(51) Int. Cl. G06Q 30/02; G06Q 50/00

(52) U.S. Cl. CPC G06Q 30/0255; G06Q 30/0269; G06Q 50/01

(57) ABSTRACT

A digital platform for interacting with a user. The interactions may include receiving first data corresponding to a user based on user input entered by the user on a user device the user is utilizing to access the digital platform, retrieving, based on the first data corresponding to the user, a second data corresponding to the user from a source external to both the digital platform and the user device, generating an enriched data set corresponding to the user based on the first data and second data retrieved from the external source and selecting a product or service to be presented to the user based on the enriched data.

### BACKGROUND INFORMATION

An entity may utilize a digital platform to autonomously interact with customers via the Internet. For example, a customer may access the digital platform to perform a transaction with the entity for a product and/or service. Typically, customers seek an easy manner of navigating a digital platform that does not require the customer to provide a considerable amount of input or spend a substantial amount of time to complete a transaction and/or access a service. Thus, the more effort required on the customer side, the less likely the customer is to use the digital platform. Accordingly, there is a need for a mechanism that improves the user experience associated with the digital platform while keeping the effort required by the customer to a minimum.

### SUMMARY

Exemplary embodiments are described that include methods performed by a digital platform. The method may include receiving first data corresponding to a user based on user input entered by the user on a user device the user is utilizing to access the digital platform, retrieving, based on the first data corresponding to the user, a second data corresponding to the user from a source external to both the digital platform and the user device, generating an enriched data set corresponding to the user based on the first data and second data retrieved from the external source and selecting a product or service to be presented to the user based on the enriched data.

In further exemplary embodiments, a server having an input/output device configured to send and receive signals over a network connection and a processor is described. The processor is configured to perform operations that include receiving first data corresponding to a user based on user input entered by the user on a user device the user is utilizing to access a digital platform, retrieving, based on the first data, second data corresponding to the user from a source external to both the digital platform and the user device, generating an enriched data set corresponding to the user based on the first data and second data retrieved from the external source and selecting a product or service to be presented to the user based on the enriched data.

### BRIEF DESCRIPTION OF THE DRAWINGS

FIG. 1 shows an exemplary arrangement according to various exemplary embodiments.

FIG. 2 shows exemplary software components of the digital platform according to various exemplary embodiments.

FIG. 3 shows a method for the digital platform to autonomously interact with the customer according to various exemplary embodiments.

### DETAILED DESCRIPTION

The exemplary embodiments may be further understood with reference to the following description and the related appended drawings, wherein like elements are provided with the same reference numerals. The exemplary embodiments are related to a device, a system, and a method to improve how a digital platform autonomously interacts with a user. As will be described below, the exemplary embodiments relate to improving the user experience associated with the digital platform and the efficiency with which the digital platform autonomously operates.

The exemplary embodiments are described with regard to a digital platform running on a server. Throughout this description the term digital platform generally refers to software that is configured to provide a digital environment that may be accessed and interacted with by a user. Any reference to the software being configured to provide a particular functionality or a particular hardware component being utilized to execute an aspect of the digital platform is only provided for illustrative purposes. The exemplary embodiments may apply to a digital platform that is configured for any type of functionality and may be executed by any type of electronic component.

The exemplary embodiments are also described with regard to a customer remotely accessing the digital platform via a web browser or a user-facing application running on the user's electronic device (e.g., mobile device, desktop computer, etc.). Throughout this description the terms “customer” and “user” may be used interchangeably and are intended to represent a person who accesses the digital platform with an electronic device via a network connection. The person may be interacting with the digital platform for her or his own purposes or on behalf of an entity. However, any reference to a user accessing the digital platform in any particular manner is only provided for illustrative purposes. The exemplary embodiments may apply to the user accessing the digital platform in any appropriate manner.

The digital platform may be configured to autonomously interact with the user. To provide a general example of a conventional interaction, consider the following exemplary scenario. Initially, a user may access the digital platform from the user's electronic device via a web browser. Subsequently, the user may be presented with a graphical user interface (GUI), e.g., a webpage. The webpage may offer any of a variety of different interactive features. The user may then select one of the features via user input entered at the user's electronic device. In response, the digital platform may provide a further webpage that includes further information and/or further interactive features. Accordingly, the user is navigating the digital environment by interacting with these features and transitioning between various webpages.

To perform a transaction using a conventional platform, the user may manually select a feature that indicates that the user wants to acquire a particular product and/or service. Subsequently, as part of the transaction process, the user may be presented with a sequence of webpages and may be required to provide a plurality of information relevant to the transaction required to establish the scope of the products and/or services that may be included in the transaction. To finalize the transaction, the user may eventually be led to a webpage that offers the user an opportunity to provide input that indicates that the user wishes to complete the transaction.

A digital platform allows an entity to autonomously interact with numerous customers at the same time via a common channel. This has had a major impact on the digital distribution landscape. However, while the adoption of the digital platform has created new opportunities, the concept of autonomously interacting with users over the Internet poses a variety of issues and problems that are specific to the functionality of the digital platform itself. For instance, Internet connectivity may make the digital platform accessible to a significant number of users that each has unique characteristics. As will be described below, the exemplary embodiments relate to solving such problems and improving the user experience associated with the digital platform by adapting the behavior of the digital platform to the unique characteristics of each user in a fast and efficient manner without human intervention on behalf of the digital platform.

The user experience associated with the digital platform may dictate whether the customer decides to complete the transaction. Typically, factors such as, but not limited to, the simplicity of the process, how easy it is to navigate the digital environment, the amount of input required by the customer, and the amount of time required to complete the transaction, may affect the user experience. Thus, the effort and resources required on the customer side may correlate to how well the digital platform attracts and retains customers.

Throughout this description the term “provider” generally refers to an entity that provides goods and/or services via the digital platform. From the provider's perspective, improving the user experience may entail improving the efficiency of the transaction process. For instance, the provider may utilize the digital platform to offer a variety of products and/or services. The provider wants the customer to be aware of the available products and/or services that are relevant to the customer without requiring the customer to provide a considerable amount of input or spend a substantial amount of time performing the transaction. The provider has to balance gathering a certain amount of information from the customer and the effort required to be put forth by the customer during the transaction process.

The exemplary embodiments relate to improving the user experience associated with the digital platform and the efficiency with which the digital platform autonomously operates. For example, the digital platform may initially receive a limited amount of information corresponding to the customer. The digital platform may then gather further information about the customer from sources external to the digital platform. Based on data enrichment derived from the information received from the customer and the further information gathered from external sources including real-time information, the digital platform may dynamically adapt its behavior to the characteristics of the customer. Accordingly, the exemplary embodiments are able to utilize a limited amount of input from the user to automatically and dynamically create a personalized experience for the user.

FIG. 1 shows an exemplary arrangement 100 according to various exemplary embodiments. The exemplary arrangement 100 includes a user device 110. Those skilled in the art will understand that the user device 110 may be any type of electronic device that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of user devices being utilized by any number of users. Thus, the example of a single user device 110 is merely provided for illustrative purposes.

The user device 110 may include a processor 111, an input/output (I/O) device 112, a transceiver 113, a display device 114 and other components 115. The other components 115 may include, for example, an audio input device, an audio output device, a battery, a data acquisition device, ports to electrically connect the user device 110 to other electronic devices, ports that provide a wired connection to an internet protocol (IP) based network, etc.

The processor 111 may be configured to execute a plurality of applications of the user device 110. For example, the applications may include a web browser or a user-facing application that the user device 110 may utilize to access the digital platform 140. The display device 114 may be a hardware component configured to display data or other information to a user while the I/O device 112 may be a hardware component that enables the user to enter inputs. The display device 114 and the I/O device 112 may be separate components or integrated together, such as a touchscreen. The transceiver 113 may be a hardware component configured to establish a connection with a wireless network, e.g., a cellular network, a wireless local area network (WLAN), etc.

The user device 110 may communicate with one or more networks. In this example, the user device 110 communicates with a WLAN 125 via an access point (AP) 120. The WLAN 125 enables the user device 110 to connect to the Internet 130. Those skilled in the art will understand that any association procedure may be performed by the user device 110 to connect to the WLAN 125. It should also be understood that the user device 110 may also communicate with other types of wireless networks (e.g., a cellular network) and the user device 110 may also communicate with networks over a wired connection. The user device 110 is only provided for illustrative purposes and is not intended to limit the exemplary embodiments to any particular type of electronic device. The exemplary embodiments may apply to any type of electronic device that is configured to communicate via a network.

The digital platform 140 may be running on a server 145. Those skilled in the art will understand that the server 145 may be any type of processing component configured to execute software and/or firmware and may also be a cloud implemented virtual environment. The server may include an input/output device (not pictured) that is configured to send and receive information over a network connection. The digital platform 140 is the digital environment created by the execution of software and/or firmware component. In the arrangement 100 only a single server 145 is depicted. However, a person of ordinary skill in the art would understand that an actual digital platform 145 may be comprised of a collection of software and/or firmware components being executed by one or more hardware components. In this example, the digital platform 140 is configured to facilitate transactions between a service provider and a customer. In some exemplary embodiments, the products and/or services may be described as relating to risk or insurance. However, any reference to a particular type of product and/or service is merely provided for illustrative purposes and is not intended to limit the exemplary embodiments to transactions that pertain to any particular type of product and/or service.

FIG. 2 shows exemplary software components of the digital platform 140 according to various exemplary embodiments. The exemplary software components will be described with regard to the arrangement 100 of FIG. 1.

The server 145 may include hardware components (e.g., one or more processors) that are configured to execute the software components of the digital platform 140. The digital platform 140 may be comprised of a dynamic transaction computation engine 210 and an intelligent digital environment routing engine 250. Generally, the dynamic computation engine 210 gathers and processes data related to the user and the intelligent digital environment routing engine 250 drives the user's journey within the digital environment. As will be described with regard to the method 300 of FIG. 3, the dynamic computation engine 210 and intelligent digital environment routing engine 250 coordinate operations to adapt the behavior of the digital platform 140, in real time and without human intervention, offer the user the products and/or services most relevant to the user's needs.

Returning to FIG. 2, the dynamic computation engine 210 may be configured to perform various operations related to gathering, synthesizing and processing data to determine characteristics of products and/or service relevant to the customer. Exemplary operations that may be performed by the dynamic computation engine 210 are described below with regard to products and/or services that are related to risk. However, any reference to risk is only for illustrative purposes, the exemplary embodiments may apply to products and/or services related to any appropriate field.

Generally, various determinations may be made based on risk. For example, the price of an insurance policy may be based on various risk factors corresponding to the user. A person of ordinary skill in the art would understand there are various formulas that may be used to determine values for risk factors. Relevant risk factors may then be aggregated by a second formula to determine a price for an insurance based product and/or service. The exemplary embodiments are not limited to utilizing any particular type of formula to determine a value for a risk factor or a price for a product and/or service. A person of ordinary skill in the art would understand the type of formulas that may be used and how they are executed. Instead, the exemplary embodiments relate to how data is gathered, synthesized and processed from various sources to determine characteristics of products and/or service relevant to the user.

In a first aspect, the dynamic computation engine 210 may be configured to integrate with various systems external to the digital platform 140 to receive information in real-time and perform batch processing on the received data. In some exemplary embodiments, this may include receiving data in a first format and converting the data to a second format for processing. Thus, the dynamic computation engine 210 is capable of receiving information from disparate sources and synthesizing the data from the disparate sources into a common format for processing.

In a second aspect, the dynamic computation engine 210 may be configured to enrich data included in an existing data set and perform machine learning algorithms on the enriched data to determine the products and/or services relevant to the user. For example, the dynamic computation engine 210 may receive a first data set based on information collected directly from the digital platform 140 interacting with the user. This data may include information such as, but not limited to, the name of the customer or the entity the customer represents, the relevant locations, the type of product and/or service the customer is looking for, etc. Based on this first set of data, the dynamic computation engine 210 may search the Internet for additional data about the customer to generate a set of enriched data derived from the first and additional sets of data. For example, the dynamic computation engine 210 may gather social media data corresponding to the customer, public reviews corresponding to the customer and any other aspect of the customer's digital footprint. Such exemplary data is used to generate an enriched data set that may be used to determine the products and/or services that may be relevant to the customer. Thus, the exemplary embodiments limit the amount of input required by the customer while still collecting enough data to perform a quick and efficient transaction. A person of ordinary skill would understand that generating an enriched data set includes performing an operation on a first set of data to generate a second set of data that includes more information than the first set of data.

In a third aspect, the dynamic computation engine 210 may be configured to perform data mining on data sets. This may include calculating values of categorical variables within the dataset to detect relationships or associations within one or more data sets corresponding to the user.

Accordingly, the dynamic computation engine 210 may be configured to communicate with various internal and external sources. For example, the dynamic computation engine 210 may receive a first set of data 215 from the intelligent digital environment routing engine 250. The first set of data 215 may be data received in response to customer interactions with the digital platform 140 and may include, but is not limited to, the customer's identity, the age of the customer, relevant insurance policy data, and types of products and/or services the customer may be interested in, etc.

The dynamic computation engine 210 may also receive a second set of data 220 from external sources 221. For example, the second set of data 220 may include information from customer relationship management software operated by the user. The second set of data 220 may also include technographic information relevant to the customer that describes the hardware and/or software the customer may utilize to operate its business. The second set of data 220 may also include firmographic information relevant to the customer that may indicate market segments relevant to the customer, the company size, the companies operating locations, etc. The second set of data 220 may also include social media data corresponding to the customer, public reviews corresponding to the customer and any other aspect of the customer's digital footprint. The second set of data 220 may also include financial information relevant to the customer, such as taxes, expenses, debts, value of assets, income, share price, etc.

The dynamic computation engine 210 may also receive a third set of data 225 from the customer's deployed devices 270. For example, the customer may operate one or more vehicles equipped with IoT devices that provide information regarding the operation of the vehicles in the field. Similarly, a manufacturing center or any other location within which the customer performs business related tasks may collect data on how employees interact with equipment, whether any accidents occur, the quantity and quality of output, etc. Further, the customer may be equipped with a wearable device or their user device 110 may collect information related to the health and activity of the customer. Accordingly, the third set of data 225 is related to data collected by devices deployed by the customer for purposes of usage-based insurance, quality control, oversight, health and lifestyle management, etc.

The dynamic computation engine 210 may also have access to a fourth set of data 230 from internal sources 231 (e.g., systems and databases internal to the digital platform 140). For example, the fourth set of data 230 may be data received directly from this customer or retrieved during this customer's previous interactions with the digital platform 140. In another example, the fourth set of data 230 may be data collected from interactions with other customers. This may include how another customer responded to a particular request or offer provided by the digital platform 140.

Reference to the above first set of data 215, the second set of data 220, the third set of data 225 and the fourth set of data 230 is only for illustrative purposes and is not intended to limit a particular type of data to a particular data set 215-230 or a particular source. Thus, the type of data referenced in each set of data 215-230 is not required to be exclusive to that indicated set of data or required to be derived from only the indicated source. For example, social media data may be received for this customer from an external source (e.g., the second set of data 220) during a previous interaction. Accordingly, an internal database (e.g., the fourth set of data 230) may now be a viable source of social media data for this customer. To provide another example, data may be derived from the customer's deployed device 270 (e.g., the third set of data 225). However, the dynamic computation engine 210 may access the data derived from the customer's deployed devices 270 via the customer's social media data or via another system operated by the customer. Thus, the dynamic computation engine 210 described herein may access any type of source for any type of data that may be used to determine products and/or services that are relevant to the customer.

Accordingly, in this example, the dynamic computation engine 210 may be able to gather, synthesize and process the first set of data 215, the second set of data 220, the third set of data 225 and fourth set of data 230 to generate an enriched data set to determine products and/or services that may be relevant to the customer. The data determined to be relevant to the customer 240 may be output to the intelligent digital environment routing engine 250 to be utilized in driving the user's journey within the digital platform 140.

The dynamic computation engine 210 is configured to gather and synthesize a substantial amount of data. In this context, efficiently gathering such a substantial amount of information is only possible with processing capabilities because the amount of time required to manually gather this data would be too detrimental to the user experience of the digital platform 140.

As indicated above, in a first aspect, the intelligent digital environment routing engine 250 manages the user flow and drives the user's journey within the digital environment. This may include determining which GUIs to present to the user on the user device 110, the type of information to request from the user and the products and/or services to offer to the user. For example, the user may initially indicate that the user is interested in a particular product and/or service. However, based on the data determined to be relevant to the customer 240, other products and/or services may also be identified as being of possible interest to the user. For instance, based on the social media data the user may be associated with a particular vehicle and thus, the digital platform 140 may suggest other products and/or services the user did not initially inquire about. In another example, based on interactions with one or more other customers (e.g., direct competitors, a similar characteristic, etc.) the digital platform 140 may suggest other products and/or services to this user that were acquired by other customers determined to be relevant to this user.

The intelligent digital environment routing engine 250 may also adapt the interactions with the user based on the data determined to be relevant to the customer 240 that was output by the dynamic computation engine 210. For example, the intelligent digital environment routing engine 250 may have numerous predetermined responses available to utilize for interactions with the customer. The intelligent digital environment routing engine 250 may select one or more predetermined response to utilize based on the data determined to be relevant to the customer 240.

Further, the intelligent digital environment routing engine 250 may develop and manage the rules that dictate how the digital platform 140 autonomously interacts with the user. For example, the intelligent digital environment routing engine 250 may identify particular associations or patterns specific to a particular type user or a particular type of interaction with the digital platform 140. During operation, the intelligent digital environment routing engine 250 may develop rules specific to the identified associations or patterns. Accordingly, as more customers utilize the digital platform 140, how the digital platform 140 autonomously interacts with customers may change. For instance, the first customer who interacts with the digital platform 140 may receive a first set of predetermined responses. However, the one hundredth customer may receive a different set of predetermined responses based on how the previous ninety-nine customers interacted with the digital platform 140.

In a second aspect, the intelligent digital environment routing engine 250 may connect the user with an external resource based on the interactions with the customer and data determined to be relevant to the customer 240. In this example, this may include offering a rate or quote to the customer and then binding the policy with a particular carrier. Thus, in addition to communicating with the user device 110, the intelligent digital environment routing engine 250 may coordinate communication with external platforms 260 (e.g., insurance carriers, managing general agents, etc.). The intelligent digital environment routing engine 250 may also offer risk consultation. This may include providing information via a live chat bot 264 for any risk factors determined to be relevant to the user or facilitating communication between the user and a risk consultant 265.

In a third aspect, the intelligent digital environment routing engine 250 may monitor for information corresponding to a service included in one or more completed transactions. Subsequently, the monitored information may trigger the intelligent digital environment routing engine 250 to perform an operation relevant to services included in the one or more completed transactions.

For example, the customer may perform a transaction for travel insurance. Accordingly, the intelligent digital environment routing engine 250 may monitor for information corresponding to the customer and the travel itinerary that is related to the scope of the travel insurance policy. This information may be received from any source and include, but is not limited to, transportation cancellations/delays, weather alerts, evacuation events, an illness/injury to the customer or a travel companion, etc. If information relevant to the travel insurance policy is identified (e.g., customer's flight is cancelled), in some embodiments, the intelligent digital environment routing engine 250 may automatically prepare and/or submit a claim without any explicit input from the customer. In other embodiments, the intelligent digital environment routing engine 250 may notify the customer of the information related to the policy or request and/or provide a recommendation to the customer for a subsequent course of action.

In another example, the customer may perform a transaction for insurance related to the transportation of cargo. The intelligent digital environment routing engine 250 may monitor for information corresponding to the customer, the cargo and the travel itinerary for the cargo that is related to the scope of the insurance policy. This information may be received from any source and include, but is not limited to, transportation cancellations/delays, weather alerts, evacuation events, the location of the cargo, the personnel transporting the cargo, a malfunction of equipment intended to protect/maintain the cargo during transportation (e.g., refrigeration equipment, heating equipment, security equipment, etc.), supplies intended to protect/maintain the cargo, etc. If information relevant to the insurance policy is identified (e.g., refrigeration equipment has malfunctioned, the cargo may enter a location that is prone to pirate attacks which are not covered under the current policy, etc.), in some embodiments, the intelligent digital environment routing engine 250 may automatically prepare and/or submit a request for further insurance to supplement the insurance policy included in the transactions. In other embodiments, the intelligent digital environment routing engine 250 may notify the customer of the information related to the policy or request/provide a recommendation to the customer for a subsequent course of action.

In another example, the intelligent digital environment routing engine 250 may recommend or trigger certain events to be performed by deployed device 270. For instance, as mentioned above, the customer may deploy an IoT device. Based on interactions with the user and the data determined to be relevant to the customer 240, the intelligent digital environment routing engine 250 may send a notification to the deployed device 270 to notify its operator or trigger the deployed device 270 to perform a particular task (e.g., reroute a vehicle out for delivery, set limits for the manufacturing process, configure a wearable device to provide notifications to the user, etc.) In some embodiments, the communication with the deployed device 270 may be intended to mitigate risk.

In a further example, the customer may perform a transaction for cold storage insurance related to crypto currencies. Cold storage of crypto currencies generally refers to storing a digital asset on an offline platform. This protects the digital asset from unauthorized access and other issues typically associated with online storage. Accordingly, the intelligent digital environment routing engine 250 may monitor for information corresponding to the customer and the relevant digital assets related to the cold storage insurance policy. If information relevant to the cold storage insurance policy is identified, in some embodiments, the intelligent digital environment routing engine 250 may automatically prepare and/or submit a request to modify the cold storage insurance policy. In other embodiments, the intelligent digital environment routing engine 250 may notify the customer of the information related to the insurance policy or request/provide a recommendation to the customer for a subsequent course of action.

FIG. 3 shows a method 300 for the exemplary digital platform 140 to autonomously interact with a customer according to various exemplary embodiments. The method 300 will be described with regard to the dynamic computation engine 210 and the intelligent digital environment routing engine 250 of FIG. 2 and the arrangement 100 of FIG. 1.

The method 300 may be described with regard to transactions related to risk and insurance. However, as mentioned above, any reference to a particular type of product and/or service is merely provided for illustrative purposes and is not intended to limit the exemplary embodiments to transactions that pertain to any particular type of product and/or service.

In 305, the user accesses the digital platform 140 using the user device 110. For example, the user device 110 may be configured with a web browser or a user-facing application that enables the user device 110 to connect to the server 145 via the network connection.

In 310, the digital platform 140 may request information from the user. For example, the intelligent digital environment routing engine 250 may configure a web page to be displayed on the user device 110 that indicates to the user the type of information to input. In response, the user may provide user input. As mentioned above, the exemplary embodiments relate to limiting the amount of input required from the user. Accordingly, there may be a minimal amount of information required from the user such as, but not limited to, identifying information (e.g., name or user, name of entity, location, etc.) and location information. Other information that may be useful but is not required may be an indication of the type of product and/or service the user is interested in, age of the user, an indication of the type of product and/or service the user is not interested in, links to relevant external sources, login information for participating external platforms and sources, etc.

In 315, the digital platform 140 may receive a first set of data corresponding to the user in response to the request. This first set of data may then be provided to the dynamic computation engine 210 for further operations.

As indicated above, the intelligent digital environment routing engine 250 may have numerous predetermined responses available to utilize for interactions with the user. If at any point between during the method 300, the digital platform 140 determines that more information is needed from the user, the intelligent digital environment routing engine 250 may interact with the customer using the available predetermined responses until the necessary minimum amount of information is received from the user.

In 320, the digital platform automatically and dynamically generates an enriched data set corresponding to the user based on the first set of data. As described above with regard to the functionality of the dynamic computation engine 210, generating the enriched data set based on the first set of data may include gathering further data corresponding to the user from a variety of different sources. For example, the enriched data set may be generated by combining the first set of data with various types of data including, but not limited to, social media data corresponding to the user, data corresponding to the user's digital footprint, financial data corresponding to the user, technographic data, firmographic data, financial data, data received from deployed devices (e.g., IoT, wearables, etc.), data from internal sources, etc.

Generating the enriched data based on the first set of data addresses several issues and problems specific to conventional platforms. For instance, as mentioned above, the more input required from the user to perform the transaction the less likely the user is to complete the transaction or utilize the digital platform in the future. By only requiring a minimal amount of data from the user, the digital platform 140 is able to provide a better user experience. However, despite the minimal efforts required by the user using the digital platform, the efficiency and quality of the transactions are significantly improved because the digital platform utilizes large sets of data automatically gathered from other sources to generate an enriched data based on the first set of data. Further, gathering data corresponding to the user may allow the digital platform 140 to offer relevant products and/or services the user may have not even known were available. Thus, generating the enriched data creates an opportunity to offer other services as well as package other added-value services to entice the customer the complete the transaction. Accordingly, the enriched data based on the first set of data allows the digital platform 140 to improve both the user experience and the efficiency of the transaction.

In 325, the digital platform 140 determines one or more relevant products and/or services corresponding to the user based on the enriched data. For example, the dynamic computation engine 210 may identify relevant insurance program structures, relevant risk mitigation techniques, the carriers that provide the best value for the customer, etc. Thus, instead of having the user take the time to navigate the digital environment and select products and/or services that the user may be interested in, the exemplary digital platform 140 is able to autonomously and dynamically develop a personalized offer that includes the relevant products and/or services specific to the customer.

In 330, a personalized offer including the one or more relevant products and/or services is presented to the user at the user device 110. For example, the intelligent digital environment routing engine 250 may configure a web page that describes the scope of the offer. The web page may include interactive features that allow the user to select one or more aspects of the offer.

In 335, the digital platform 140 determines whether the user has selected any aspects of the personalized offer. If the user does not select any aspects of the personalized offer the method 300 ends. However, this does not mean that the user is disconnected from the digital platform 140 or that the digital platform 140 automatically disengages (e.g., web page or user-facing application closes). At this point, the user is free to navigate the digital environment. For example, in response to user input at the device, the digital platform may be triggered to return to 310, e.g., request information via a web page.

If the user selects one or more aspects of the personalized offer, the method 300 continues to 340. In 340, the user is configured with the selected aspects of the personalized offer. For example, this may include the intelligent digital environment routing engine 250 perform operations such as, but not limited to, connecting the user with a risk consultant 265, binding a policy with a carrier from one of the external platforms 260, etc. Accordingly, the transaction has been completed. However, as demonstrated below in 345-355, once the user has completed the transaction, the digital platform may continue performing various operations on behalf of the customer.

In 345, the digital platform 140 monitors for information corresponding to a service included in the completed transaction. For example, the user may have selected a service related to deployed device 270. Accordingly, during the lifespan of the agreement, the digital platform may monitor for indications of risk events associated with the deployed device 270.

In 350, the digital platform determines whether a predetermined condition has been identified. The predetermined condition may indicate to the digital platform 140 that an action corresponding to the product and/or service the user transacted for should be performed by the digital platform in accordance with the agreement. For example, the user may have transacted for a service where the digital platform 140 is to implement risk mitigation techniques at the deployed device 270. In this scenario, the predetermined condition may indicate that a risk has occurred or is imminent. This may occur if a deployed device 270 indicates to the digital platform 140 that a vehicle or manufacturing component has malfunctioned. If the predetermined condition is not identified, the method 300 returns to 345. If the predetermined condition is identified the method 300 continues to 355.

In 355, the digital platform performs an action in response to the predetermined condition. In some exemplary embodiments, the action may be a behavioral change implemented at the digital platform. In other exemplary embodiments, the action may be providing a notification to either the user device 110 or the contact information corresponding to the user. In another exemplary embodiment, the action may be implementing a risk mitigation technique, which includes notifying the customer of a risk event or an imminent risk event. Notifying the user may include sending a notification to the user device 110, the deployed device 270 or sending the notification to the contact information of the user. In other exemplary embodiments, the risk mitigation technique may include altering or modifying the operation of the deployed device 270. For example, this may include altering the route or destination of a delivery vehicle or altering the performance of a piece of manufacturing equipment. Subsequently, the method 300 ends.

The exemplary embodiments describe various mechanisms related to improving the user experience associated with a digital platform and/or the efficiency with which the digital platform operations. The exemplary digital platform 140 may be used in conjunction with currently implemented digital platforms, future implementations of digital platforms or independently from other digital platforms. Any aspect of the exemplary embodiments may be incorporated into a digital platform to enhance the user experience and/or improve the efficiency of a digital platform.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a Linux based OS, a mobile device having an operating system such as iOS, Android, etc. In a further example, the exemplary embodiments of the above described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A method, comprising:
at a digital platform:
receiving, from a user device a user is utilizing to access the digital platform, user input including first data comprising a user selection of a first product or service that is available through the digital platform, wherein the first product or service is a first type of product or service;
retrieving, based on the first data corresponding to the user, a second data corresponding to the user from a source external to both the digital platform and the user device;
generating an enriched data set corresponding to the user based on the first data and second data retrieved from the external source; and
selecting a second type of product or service to be presented to the user based on the enriched data, wherein the second type of product or service is different than the first type of product or service the user inquired about via the user input.

2. The method of claim 1, further comprising:
receiving an indication that the user selected the second product or service; and
monitoring for information corresponding to the second product or service.

3. The method of claim 2, further comprising:
when monitoring for information, identifying a predetermined condition corresponding to the second product or service; and
performing an action in response to the predetermined condition.

4. The method of claim 3, wherein the action includes notifying the user of an event corresponding to the second product or service.

5. The method of claim 3, wherein the predetermined condition is based on a risk event and the action includes implementing a risk mitigation technique.

6. The method of claim 3, wherein the predetermined condition is based on receiving information from a device deployed by the user.

7. The method of claim 1, wherein the second data includes social media data corresponding to the user.

8. The method of claim 1, wherein the second data includes one or more of firmographic data and technographic data.

9. The method of claim 1, wherein the second data includes data received from a device deployed by the user, wherein the device is one of a wearable device or an Internet of Things (IoT) device.

10. (canceled)

11. The method of claim 1, wherein enriching the first data using the second data is based on interactions between the digital platform and other users.

12. The method of claim 1, wherein the enriching the first data further includes using data from sources included in the digital platform.

13. A server, comprising:
an input/output device configured to send and receive signals over a network connection; and
a processor, the processor configured to perform operations comprising:
receiving, from a user device a user is utilizing to access the digital platform, user input including first data comprising a user selection of a first product or service that is available through the digital platform, wherein the first product or service is a first type of product or service;
retrieving, based on the first data, second data corresponding to the user from a source external to both the digital platform and the user device;
generating an enriched data set corresponding to the user based on the first data and second data retrieved from the external source; and
selecting a second type of product or service to be presented to the user based on the enriched data, wherein the second type of product or service is different than the first type of product or service the user inquired about via the user input.

14. The server of claim 13, the operations further comprising:
receiving an indication that the user selected the second product or service; and
monitoring for information corresponding to the second product or service.

15. The server of claim 14, the operations further comprising:
when monitoring for information, identifying a predetermined condition corresponding to the second product or service; and
performing an operation in response to the predetermined condition.

16. The server of claim 15, wherein the operation includes notifying the user of an event corresponding to the second product or service.

17. The server of claim 15, wherein the predetermined condition is based on receiving information from a device deployed by the user.

18. The server of claim 13, wherein the second data includes social media data corresponding to the user.

19. The server of claim 13, wherein the second data includes firmographic data.

20. The server of claim 13, wherein the second data includes data received from a wearable device.

21. (canceled)

22. The server of claim 13, the operations further comprising:
selecting one or more predetermined responses to the first data based on the second data.
